(19) United States
(12) Patent Application Publication
(10) Pub. No.: US 2018/0133977 A1
(43) Pub. Date: May 17, 2018

(54) CONTROL METHOD AND SYSTEM AND ADJUSTMENT OF OPERATION VARIABLE OF HIGH-FREQUENCY WELDING AND CUTTING EQUIPMENT

(71) Applicant: ORISOL DO BRASIL INDÚSTRIA E COMÉRCIO DE MÁQUINAS LTDA, Campo Bom (BR)

(72) Inventors: Cauê LUAN DOS SANTOS PEREIRA, Porto Alegre (BR); Alecsander Da Silva Couto FÁBIO, Porto Alegre (BR)

(21) Appl. No.: 15/563,992

(22) PCT Filed: Mar. 8, 2016
(86) PCT No.: PCT/IB2016/051313

§ 371 Date: Oct. 3, 2017

(30) Foreign Application Priority Data
Apr. 7, 2015 (BR) PI102015007771-8

(51) Int. Cl. B29C 65/00; B29C 65/04; B29C 65/74

(52) U.S. Cl. CPC B29C 66/91651; B29C 65/04; B29C 66/9241; B29C 66/963; B29C 66/8322; B29C 65/745

(57) ABSTRACT

A system and method to control and adjust operation variables of high frequency welding and cutting equipment is described that allows to adjust the operation frequency and pressure of high-frequency welding and cutting equipment, with the possibility to perform automatic variations to increase or decrease the power based on historical data stored in memory, to promote the welding and cutting of leather, synthetic and plastic laminated materials.

### INVENTION FIELD

This present invention describes a system and method to control and adjust operation variables of high frequency welding and cutting equipment. More specifically, it comprises a system and its method that allow to adjust the operation frequency and pressure of high frequency welding and cutting equipment, with the possibility to perform automatic variations to increase or decrease the power based on historical data stored in memory, to promote the welding and cutting of leather, synthetic and plastic laminated materials.

### INVENTION BACKGROUND

High-frequency welding (High Frequency—HF), also known as Radio Frequency Welding or Dielectric Welding, is based on the physical principle called dielectric losses, through which a nonconductive substance dissipates energy when submitted to the action of an alternating electric field [Jeronimo, Joice Luiz. Welding machine modeling by electromagnetic induction in RF/Joice Luiz Jeronimo.—Campinas, SP: [s.n.], 2009.].

This happens because the molecules of the material placed under the influence of the electric field polarize. It is a known fact that a bipolar element placed under the action of an electric field will align with the molecular field in such a way that the positive pole is faced with the negative end of another molecule, and vice versa, guiding in the same direction of itself (positive-negative-positive . . . ) [FLAWS, M., Ed (1996). Welding Handbook: Materials and application. American Welding Society.]. The frequency of the electric field varies this direction, and then the molecules are guided variably, concluding then that once submitted to the action of a high-frequency alternating field, the molecular friction will produce thermal energy dissipation.

In the high-frequency welding process, control and precise adjustment of the variable time, exposure and pressure ensure the welding efficiency, which must consider the work surface to be welded. Thus, a high-amplitude alternating electric field is applied to the workpiece to be welded, and the heat generated inside the workpiece promotes the fusion at the points where the electric field concentrates. The application of pressure at this point with enough cooling time creates a permanent bond.

Equipment that performs high-frequency welding typically has three stages: a generating source of electromagnetic energy, shielding and filtering through a resonant cavity that confines the electromagnetic energy and has large areas for current circulation, eliminating radiation and reducing losses, and a charging power. The source excites a cavity that resonates and operates as a carrier of electromagnetic radiation and a frequency filter. The cavity energy is extracted through a transmitter and placed in contact with the workpiece. Once the welding process is performed from a located and controlled fusion process, the area is cooled so that the hardening of the material forming the bond or weld, completing the welding process.

The state-of-the-art describes diverse high-frequency welding equipment.

Document PI0302603 describes a resonant cavity for radio frequency welding equipment, comprising three aluminum parallelepiped boxes, one external, one intermediate and one internal, arranged one inside the other, and on the inside the generating elements of the electromagnetic field are placed.

Document CN2035308 describes a resonant cavity comprising an internal cavity formed by two aluminum cylinders with different diameters and an external cavity comprising an aluminum cylinder with a large diameter, whereas the internal cavity and the external interconnected by rivets or screws.

Document PI0901420 describes a high-frequency machine to weld and cut applied in footwear production developed with hydropneumatic technology, consisting of a left side plate and a right side plate provided, in its upper part, with a hydraulic cylinder and a pneumatic cylinder that trigger the movable plate that has ascendant and descendant movement, and is located on the workbench. The front part of the mentioned machine consists of a plate at the top and a plate at the bottom, fastened by support feet, and the assembly is superiorly closed by the plate. Internally, the mentioned machine consists of an electric motor connected to a reducer.

Document PI0700196 describes high-frequency welding equipment with a phase for cutting, die and part stamping and cutting method using the mentioned equipment and die, whereas the high-frequency welding equipment is provided with a press that provides part cutting by stamping, using a die provided with a groove around the stamping area of the mentioned die, in the groove being inserted into a steel blade that cuts the workpiece by action of the press of the high-frequency welding equipment, reducing manufacturing steps by eliminating the need for stamping on one piece of equipment and cutting in a balancer.

Document U.S. Pat. No. 3,413,173 describes improvement in a press for cutting and welding of parts to make footwear, where a knife is assembled in the press. A high-frequency electric field is established to respond to the air supply under pressure to the piston so that when the knife contacts the workpiece, a high-frequency electric field is established between the knife and the workpiece. The knife is kept in welding position for a predetermined period of time, and at the end, the high-frequency current is cut off and the press is operated to press the cutting edge to internally cut and weld the material.

In state-of-the-art high-frequency welding equipment, the operator must define several equipment operation variables according to the specifics of the work material, performing manual adjustments as the processing is performed. That is, human intervention in the working frequency adjustment was performed empirically, based on attempts and linked to the expertise of the operator.

However, in order to be obtain a more stable result and to ensure optimal operation conditions of the equipment, the object of this present invention is a system to control and adjust operation variables of high-frequency welding equipment where the operator informs the pressure and frequency variables appropriate and known to the work surface to be welded, and a controller adjusting equipment operation conditions based on data stored in memory, avoiding manual intervention in the adjustment of the frequency, which in this case is kept constant.

Still, the equipment has a quadrangular resonant cavity, unlike equipment with the same purpose that have spherical or cylindrical resonant cavities that produce greater difficulty to control the direction of wave propagation, causing the formation of stationary waves within the cavity, allowing less control and loss of energy efficiency. On the contrary, the quadrangular resonant cavity allows to obtain a high-frequency system with only the triode tube and the combination of capacitors, with the cavity circuits releasing more power for the application with lower energy consumption and lower release of radio frequency in the environment around the equipment, allied with the fact that the power dissipation is less than in discrete components, improving the Q Factor of the resonant circuit, and ensuring the ease of tuning.

### BRIEF DESCRIPTION OF THE FIGURES

FIG. 1 shows a schematic representation of the construction elements of high-frequency welding equipment.

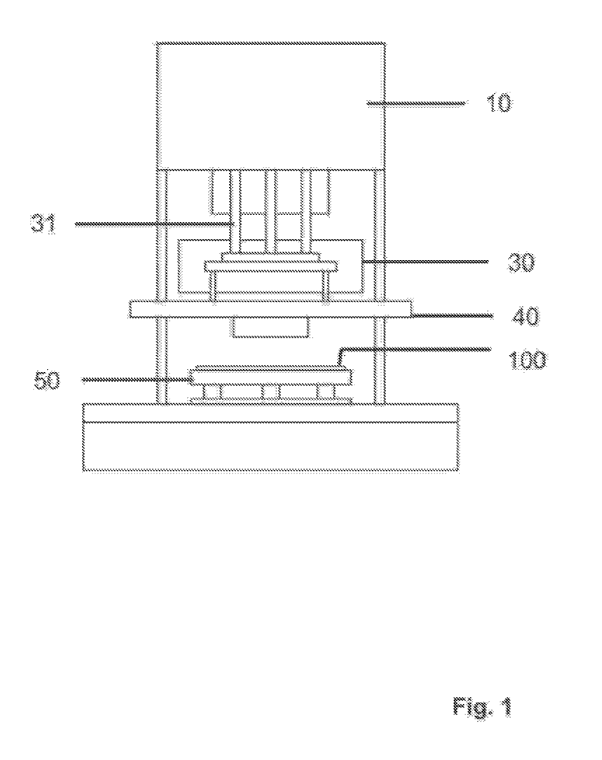

FIG. 2 shows a perspective view of the quadrangular resonant cavity of the high-frequency welding equipment.

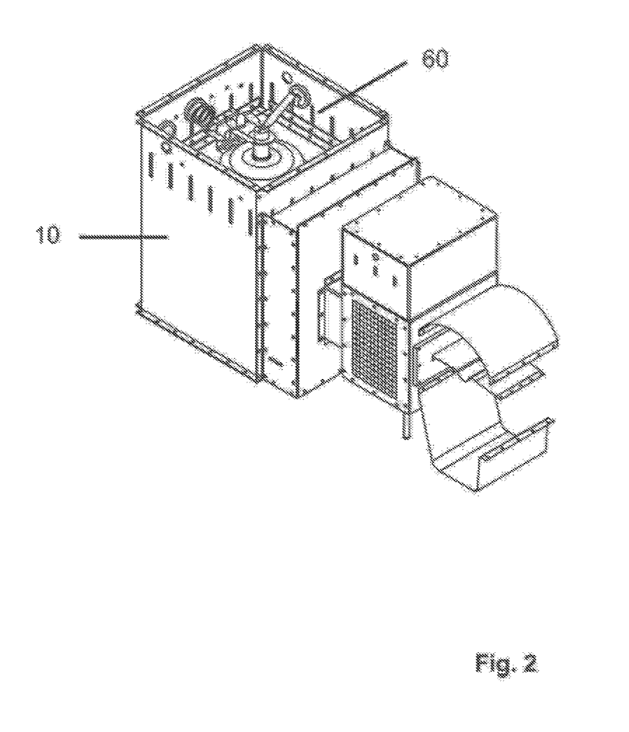

FIG. 3 shows the adjustment flowchart of the pressure and flow variables.

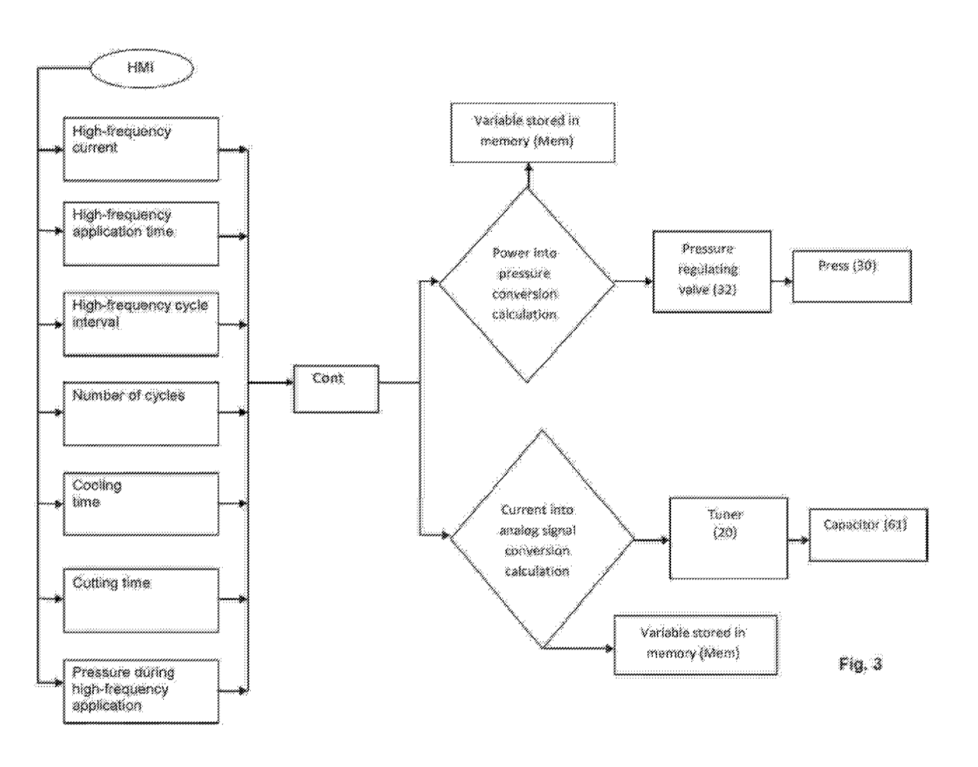

### DETAILED DESCRIPTION OF THE INVENTION

Conventional high-frequency welding and cutting equipment consists of a generator (10) that transforms electrical energy into high-frequency energy, a tuner (20) which regulates the high-frequency energy transfer to the material to be welded (100), as to transfer the power required for welding within the specification, a press (30) which complete the welding of the material, such press (30) that moves vertically towards a mold (electrode) (40) under pressure on a table (50) where the workpiece is positioned (100) to be welded which is submitted to uniform heating due to dielectric losses that develop with the passage of the high-frequency current generated in the resonant cavity (60) where a high-frequency electric field is generated through capacitive and inductive circuits.

The electrode (40) has knives fastened on a plate to cut the welded workpiece (100), facilitating the removal of such workpiece (100).

The resonant cavity (60) has a quadrangular shape, such cavity (60) provided with a capacitor (61) connected to a tuner (20) in turn connected to the controller (cont) of the equipment.

In the high-frequency welding and cutting equipment, an interface (HMI) is foreseen, where the operator adjusts the pressure and the frequency of work, with the possibility to perform automatic variations to increase or decrease the power based on historical data stored in the controller's memory.

In the interface (HMI) of the high-frequency welding and cutting equipment the user adjusts the process variables, informing the high-frequency current, the time of high-frequency application, the high-frequency cycle interval, the number of cycles, the cooling time, the cutting time, the pressure during high-frequency application, the pressure for the cutting and the sequence of the cutting process.

Input data entered by the operator in the interface (HMI) are sent to the controller (Cont), where processing is made that includes the power conversion calculation in pressure as to send the obtained data to the pressure regulating valve (32) of the cylinder (31) of the press (30), and the current conversion calculation in analog signal as to adjust the tuner (20) that adjusts the capacitor (61) of the resonant cavity (60) to control the power released on the workpiece (100).

Input data entered by the operator in the interface (HMI) of the equipment are stored in the memory (Mem) of the controller (Cont) associated with the data processed by the controller (Cont) (output data).

1. CONTROL AND ADJUSTMENT SYSTEM OF OPERATION VARIABLES OF HIGH-FREQUENCY WELDING AND CUTTING EQUIPMENT comprising a generator (10) that transforms electrical energy into high-frequency energy, a tuner (20) which regulates the high-frequency energy transfer to the material to be welded (100), as to transfer the power required for welding within the specification, a press (30) which completes the material welding, such press (30) that vertically moves towards a mold (electrode) (40) provided with knives, such electrode (40) suffers pressure on a table (50) where the workpiece is positioned (100) to be welded that is submitted to uniform heating with the passage of the high-frequency current generated in the resonant cavity (60) where a high-frequency electric field is generated via capacitive and inductive circuits, comprising a quadrangular resonant cavity (60), such cavity (60) provided with a capacitor (61) connected to a tuner (20) which, in turn, is connected to the controller (cont) of the equipment adjusted through an interface (HMI).

2. CONTROL AND ADJUSTMENT SYSTEM OF OPERATION VARIABLES OF HIGH-FREQUENCY WELDING AND CUTTING EQUIPMENT comprising an interface (HMI) to adjust the variables:
a) input data related to the pressure informed in the interface (HMI) and sent to the controller (Cont) where processing is performed that includes the power conversion calculation in pressure as to send the obtained data to the pressure regulating valve (32) of the cylinder (31) of the press (30), being the input data and output data stored in the memory (MEM) of the controller (Cont);
b) Input data related to the working frequency informed in the interface (HMI) and sent to the controller (Cont) where processing is performed that includes the current conversion calculation to an analog signal to adjust the tuner (20) that performs capacitor adjustment (61) of the resonant cavity (60) to control the power released on the workpiece (100), being the input data and output data stored in the memory (MEM) of the controller (Cont).
